(19) United States
(12) Patent Application Publication
(10) Pub. No.: US 2013/0268516 A1
(43) Pub. Date: Oct. 10, 2013

(54) Systems And Methods For Analyzing And Visualizing Social Events

(71) Applicants: Imran Noor Chaudhri, Potomac, MD (US); Musa Ghani, Vienna, VA (US)

(72) Inventors: Imran Noor Chaudhri, Potomac, MD (US); Musa Ghani, Vienna, VA (US)

(21) Appl. No.: 13/858,810

(22) Filed: Apr. 8, 2013

Related U.S. Application Data
(60) Provisional application No. 61/620,983, filed on Apr. 6, 2012.

(51) Int. Cl. H04L 29/06

(52) U.S. Cl. CPC H04L 65/403
USPC 707/722; 709/204; 709/207; 707/737; 707/739

(57) ABSTRACT

Systems and methods for analyzing and visualizing social events include historical, real-time, and predictive analytics and visualization of physical or virtual social events based on social network communications.

### RELATED APPLICATION

This application is related to, and claims the benefit of priority from, U.S. Provisional Application No. 61/620,983 the contents of which are incorporated by reference herein as if set forth in full herein.

### BACKGROUND OF THE INVENTION

This invention relates generally to the field of digital social networks. More particularly, the invention relates to an analysis and visualization system designed to allow users to easily analyze, visualize, and understand physical or virtual social events. Computer systems and hand held devices, collectively called computing devices, are continuing to grow their capacity in several dimensions: permanent storage, networking bandwidth, memory, processing power, geo-location services, and wireless communication services. Mobile computing devices that allow for on the go digital interactions include regular phones with text capability, smartphones, tablets, and laptop computers. Users of these computing devices now can participate in real time on the go in digital social networks. Popular social network examples include Twitter, Facebook, LinkedIn, Youtube, Pinterest, Instagram and Google+. Often people cross link these social networking service such that a posting on one automatically shows up on their accounts on the other social networks. Most of the communications at an event are performed through twitter as their platform is the most mobile and most readily available. In Twitter these communications are called “tweets”.

People get together for physical or virtual social events on a regular basis for many purposes including entertainment and sharing knowledge. Some examples of entertainment events include concerts, social video games, movies, and theater. Examples of events for sharing knowledge include conferences, trade shows, school classes, university classes, grand rounds in medicine, digital conferences, and meet-ups. Examples of virtual social events include events in virtual environments such as second life, virtual conferences, or massively multiplayer online games (MMOGs).

Organizers of the events generally encourage people to get together and communicate digitally about the event by providing a user ID, or keyword (also known as a hashtag in Twitter) for that event. Going forward we will refer to these as collectively as event keyword(s). People interested in talking about the event digitally include the events keyword(s) in their communications. People interested in the event then follow the event digitally by searching for stream of that particular event keyword(s) of interest. If people following the event find a particular communication interesting, they can amplify that communication by “Like”ing it or “retweeting” it; referred hereinafter as amplification.

Generally, real-time analytics of social events is currently limited to viewing the digital communications of people at the event in a single real-time search stream. While this provides a quick view of what is going at an event, this simple view has many disadvantages.

### Disadvantages Include:

In large events, there are too many communications occurring; as a result, users have a hard time following all the communications. In other words the “signal” of interest to the user is lost in the “noise” of all the communications.
In events with multiple simultaneous sessions, users interested in just their session have a hard time finding the communications for just their sessions. Again, the “signal” of interest to the user is lost in the “noise” of all the communications.
Users have a hard time filtering communications for just the communications they are interested in.
Users don't see where or which session people they are interested in are congregating.
   Users can't easily determine which communications or sessions are most popular.

### SUMMARY

The following summary provides an overview of various aspects of the invention. This summary is not intended to provide an exhaustive description of all of the important aspects of the invention, nor to define the scope of the invention. Rather, this summary is intended to serve as an introduction to the detailed description and figures that follow. This summary explicitly includes the claimed inventions set forth at the end of this text though for the sake of efficiency the text of the claims will not be repeated verbatim herein.

In view of the aforementioned deficiencies in existing social event analytics and visualization systems, there is a need for a new system and method for the Analysis and Visualization of Social Events (“Aavose”) that provides the following functions:
Allow users to define and/or automatically determines the “signal” communications of interest among all the “noise” of uninteresting communications and receive that signal as a special priority or in a separate high priority communications channel (e.g. SMS). Signal communications of interest could be defined based on many kinds of criteria such as:
   key words in the communication
   time constraints
   Natural language processing or semantic analysis of example communications
   User action triggered
   User account content triggered
Allow users to create/edit/correct (where correct refers to users correcting incorrect facts created or edited by other users) unique analytics and visualization templates for events (crowd sourcing) with the ability to define:
   Temporal aspects of the events such as schedules
   Spatial aspects of events such as different rooms or exact geospatial locations
   Relational aspects of events such as speakers, followers, following, and influencing
   Media aspects of events such as keywords/text, pictures, sounds, and videos
Allow users to easily and/or automatically tag their communications with the specific temporal, spatial, relational, or media aspects of the event they are attending or experiencing.
Allow users to easily and/or automatically tag their various relationships to other users such as speakers, followers, following, and influencing with various user customized groups, priorities, or interests.
Allow users to easily identify speaker/presenter users, followers, following and influencers with the specific temporal, spatial, relational or media aspects of the event they are attending or experiencing.
Allow users to easily identify quantity or other metadata of communications, quantity or other metadata of amplifications with the specific temporal, spatial, relational, or media aspects of the event they are attending or experiencing.
Allow users to easily determine the most popular aspects of the specific temporal, spatial, or relational aspects of the event they are attending or experiencing, and allows business partners to analyze and visualize their user base and to reach out and affect user behavior.

### BRIEF DESCRIPTION OF DRAWINGS

The foregoing summary, as well as the following detailed description of the invention, is better understood when read in conjunction with the appended drawings. For the purpose of illustrating the invention, there is shown in the drawings exemplary embodiments of various aspects of the invention; however, the invention is not limited to the specific systems and methods. In the drawings:

FIG. 1 is a diagrammatic illustration of a typical digital social networks environment within an event context.

FIG. 2 is a diagrammatic illustration of how a system provided by the present invention relates digital social networks to an event according to an embodiment of the invention.

FIG. 3 is a diagrammatic illustration of high level components of a system that provides analytics and visualization of social networks of a social event according to an embodiment of the invention.

FIG. 4 is a diagrammatic illustration of a basic twitter tweet visualization.

FIG. 5 is a diagrammatic illustration of an exemplary event visualization according to an embodiment of the invention.

FIG. 6 is a diagrammatic illustration of an exemplary sequence/flow diagram for social events analytics according to an embodiment of the invention.

FIG. 7 is a diagrammatic illustration of an exemplary sequence/flow diagram for real-time alerting analytics according to an embodiment of the invention.

FIG. 8 is a diagrammatic illustration of an exemplary visualization according to an embodiment of the invention.

### DETAILED DESCRIPTION, WITH EXAMPLES

The subject matter of the present invention is described with specificity to meet statutory requirements. However, the description itself is not intended to limit the scope of the invention. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

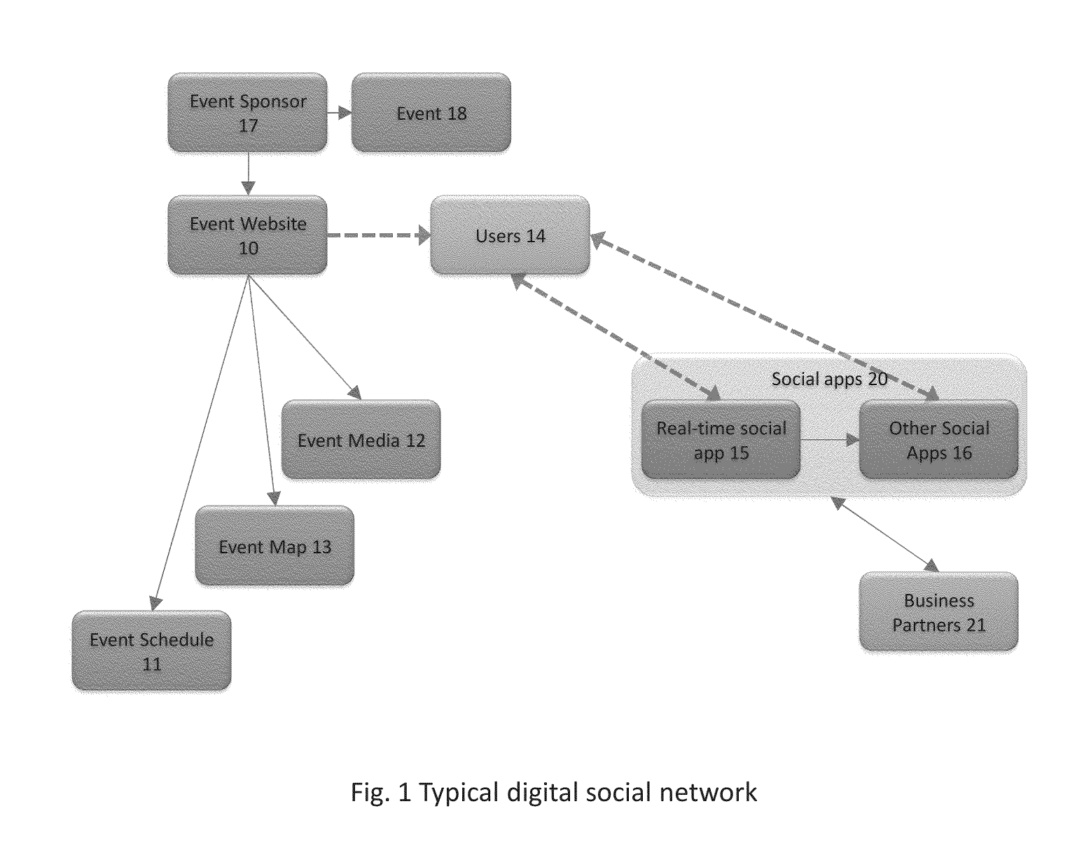

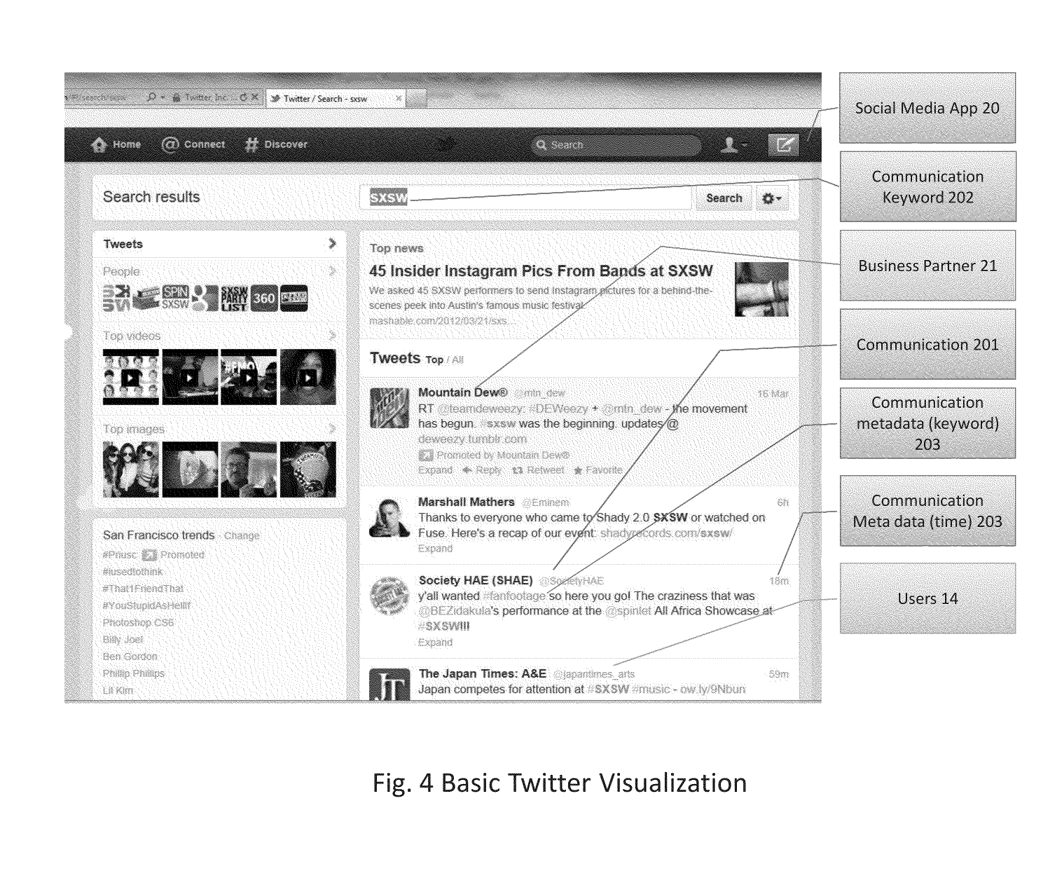

A typical existing digital social network environment within an event context is displayed in FIG. 1. The event sponsor 17 of an event 18 creates an event website 10 which usually contains an event schedule 11, event media 12 and event map 13. Event users 14 may also be able to login and create a user specific event schedule 11. Event media 12 are usually limited to static keywords such as event hashtags or the event sponsor's 17 user handles on twitter or other social networks. The event map 13 is usually a static map representing the physical or virtual meeting points in the event 18. The mapping between an event 18 and digital social networks is performed manually by the users 14. In particular the user 14 looks up the event media 12 and starts searching, and generating communications based on them. When users 14, search for communications or “tweets” on the real time social app (e.g. twitter) 15 or other social app 16, collectively referred to as social apps 20, users 14 typically get a single dimensional view usually based on time or sponsorship by business partners 21) of the communications with the keyword as shown in FIG. 4,the basic twitter tweet visualization. In this particular example the keyword 202 (communication feature of interest)is “sxsw” which, by way of example, may be the hashtag for a popular conference named the south by southwest conference held in Austin, Tex. and a “promoted” tweet by business partner 21, Mountain Dew is displayed. The communications 201 are displayed linearly. A keyword 202 chosen by the author is meta-tagged 203 with a # character. Another meta-tag 203 time is also shown. While this provides a quick view of what is going on at an event, this simple view has many disadvantages. Disadvantages include:
In large events 18, there are too many communications occurring and, as a result, users 14 have a hard time following all the communications.
In events 18 with multiple simultaneous sessions, users 14 interested in just their session have a hard time finding the communications for just their sessions.
Users 14 have a hard time filtering communications for just the people they are interested in (e.g. followers, following, or key influencers)
Users 14 don't see where or which session people they are interested in are congregating.
Users 14 can't easily determine which communications or sessions are most popular.

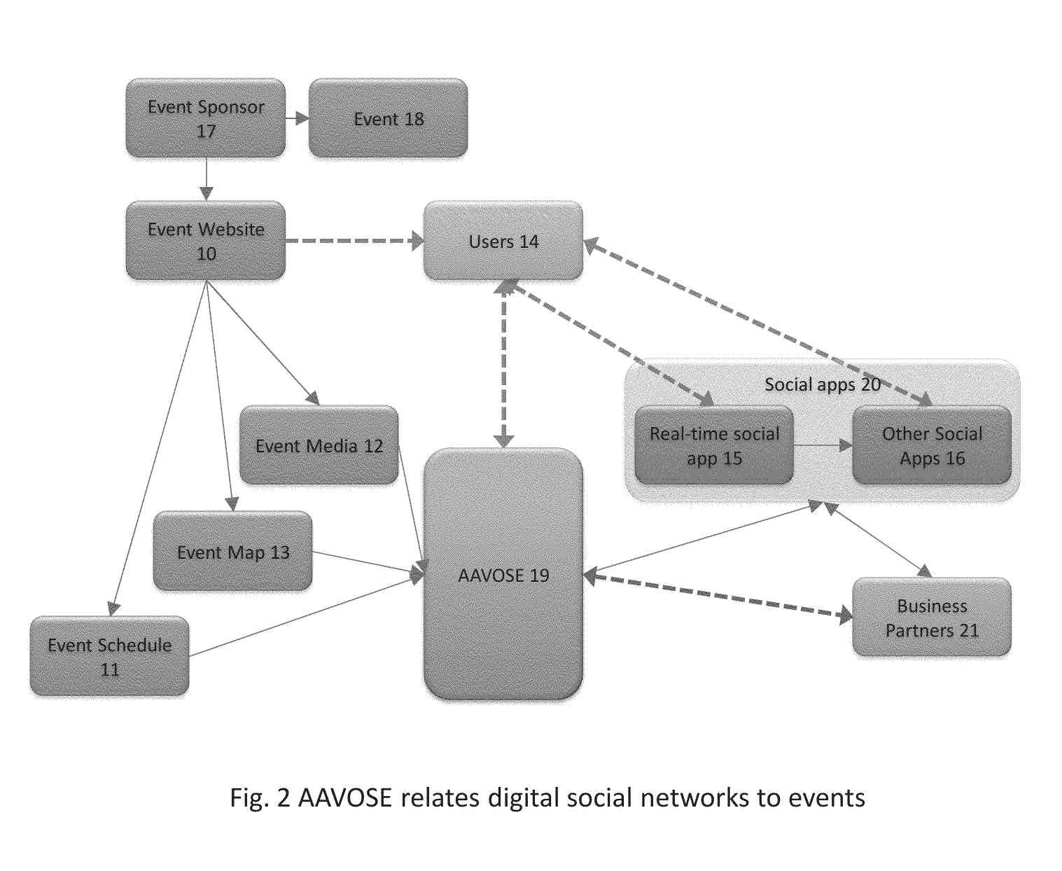

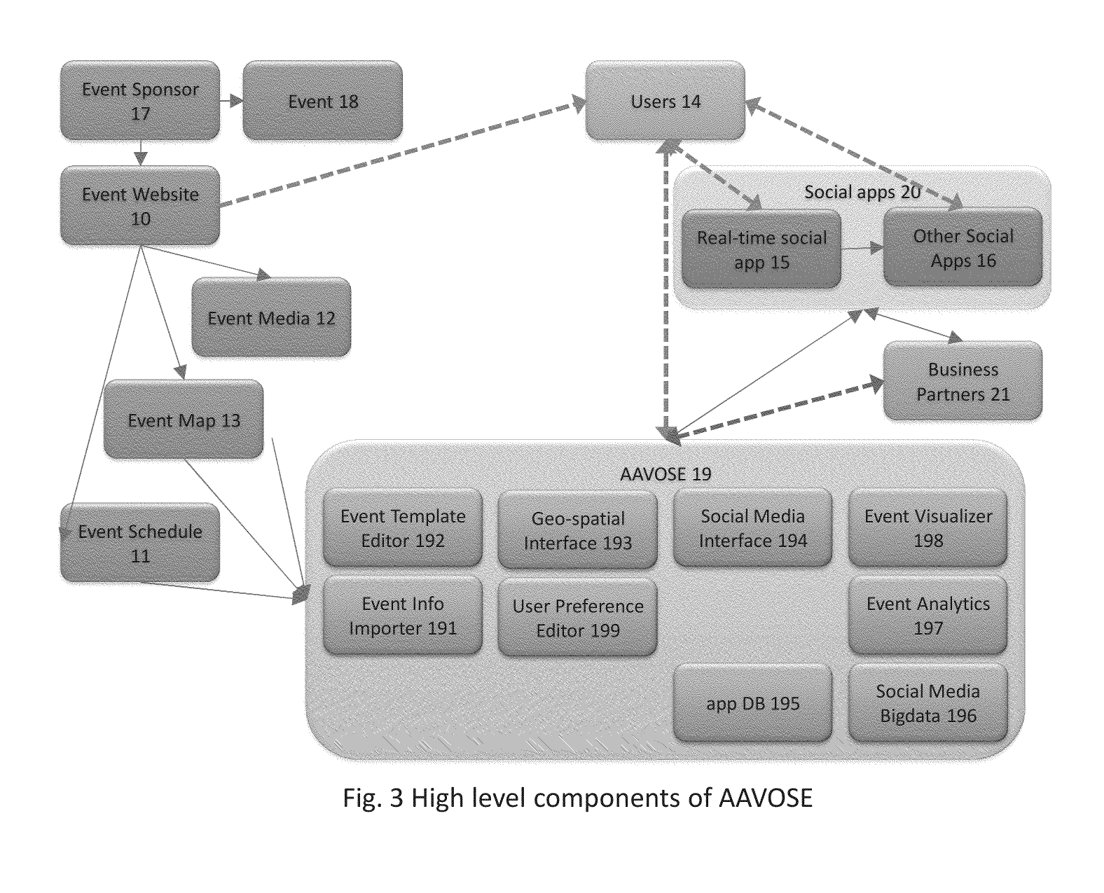

The components described in the following paragraphs are shown in FIG. 2 and FIG. 3. In accordance with an embodiment of the present invention, a system 19 (and related methods) for the analysis and visualization of social events is depicted that provides a solution to the above problems. It should be under stood that the term “users” as used herein includes any user in any role or function of the system. By way of example only, users 14 can include the end users of the system 19, the event sponsors 17, business partners 21, and/or any other event related physical or virtual participants such as speakers/presenters, followers, following users of any of the social media apps 20.In one embodiment of the invention the system 19 may comprise one or more processors operable to execute instructions stored in associated memory for completing the functions and features of the invention described herein. For example, system 19 may be operable to complete the following functions:
Allow users 14, event sponsors 17, or business partners 21 to define and/or automatically determine the “signal” or communications of interest (e.g., a tweet from an individual a user follows a lot) (collectively a signal or communication of interest may be referred to as a “signal of interest” herein) among all the “noise” of uninteresting communications and receive that signal as a special priority or in a separate high priority communications channel (e.g. SMS, special social network or email account). It should be understood that the system 19 includes all of the necessary electronics, circuitry and programming to receive these signals, and such circuitry, etc., is well known in the art and need not be discussed herein. The signals of interest maybe any communications, metadata related to those communications or any additional user entered information. By way of example, user entered information may include user preferences or user configured groups. Additional examples of communications or metadata that may be considered signals of interest include:
   Key words in the communication
   Date/time ranges
   Natural language processing or semantic analysis of example communications. By way of example only, semantic analysis can be performed by extracting common features from the communications and comparing new communications for similar or different features.
   User action triggered such as retweets or likes
   User account content triggered such as the number of friends receiving a particular communication
   User geospatial location triggered.

In an embodiment of the invention, the system 19 may be operable to receive, extract or select and prioritize one or more signals of interest. Some examples of the type of signals of interest that may be extracted and prioritized are:
If communication occurs from a user of interest with the key words “starting” “game” during between 6am and might night, SMS the message directly to my cell phone and email it to my high priority account.
If at least five of my friends who receive the same communication with the key word “party” in it, SMS the message directly to my cell phone.
If a user or users of interest are in a nearby location send and SMS an alert directly to my cell phone.
If a user of interest takes a specified number of actions within a short time period, e.g. 10 tweets in 5 minutes, SMS an alert directly to my cell phone.
   If the same piece of communication is amplified by at least four of my friends SMS the message directly to my cell phone.

In an additional embodiment of the invention the system 19 may be operable to us provide users 14, event sponsors 17, or business partners 21 with recommendations and/or reminders. By way of example, recommendations may include new communications to originate or amplify, or new users 14, events 18, or business partners 21 to build relationships with.

In yet a further embodiment the system 19 may be operable to allow users 14 to create/edit/correct (where correct refers to users correcting incorrect facts created or edited by other users) unique analytics and visualization templates for events 18 (crowd sourcing) with the ability to define:
Temporal aspects of the events 18 such as schedules
Spatial aspects of events 18 such as different rooms or exact geospatial locations
Relational aspects of events 18 such as speakers, followers, following, and influencing
Media aspects of events 18 such as keywords/text, pictures, sounds, and videos

In still additional embodiments the system 19 may allow users 14 to easily and/or automatically tag their communications with the specific temporal, spatial, relational, or media aspects of the event 18 they are attending or experiencing; allow users 14 to easily and/or automatically tag their various relationships to other users 14 such as speakers, followers, following, and influencing with various user customized groups, priorities, or interests; allow users 14 to easily identify speaker/presenter users, followers, following and influencers with the specific temporal, spatial, relational or media aspects of the event 18 they are attending or experiencing; allow users 14 to easily identify quantity or other metadata of communications, quantity or other metadata of amplifications with the specific temporal, spatial, relational, or media aspects of the event 18 they are attending or experiencing; allow users 14 to easily determine the most popular aspects of the specific temporal, spatial, or relational aspects of the event 18 they are attending or experiencing.

It should be understood that the phrase “allows users” means at least that a user or users inputs or otherwise selects information that is input into the system 19, and, thereafter the system 19 is operable to execute instructions stored in associated memory to use the data or other information input into the system 19 to complete a particular function or feature.

FIG. 2 depicts an example of how the system 19may relate events 18 to digital social apps 20 (twitter 15 and other social apps 16). In one embodiment the system 19 allows for the automatic and manual (user 14 directed) import and definition of event 18 parameters such as event schedule 11, event media 12, and event map 13. System 19 may allow users 14 to easily generate automatically tagged content for social apps 20. The system 19 may also provide historical, real-time and predictive analytics for business partners 21. By way of example only, business partners 21 could include the event sponsor 17, advertisers, and any other organizations interested in the analytics of the data and metadata being collected.

In the context of today's Internet, it is understood that users 14 can access the event website 10, social apps 20, and system 19, through a multitude of mobile and fixed end-user devices such as simple text phones, smartphones, tablets, laptops, PCs, TVs, and terminals. It is also understood that system 19 may include Internet applications. In an additional embodiment of the invention the functions and features completed by the system 19 may be completed by one or more hardware servers making up a part of the Internet. Still further, some of the functions and features of the system 19 may be completed by one or more processors executing instructions stored in one or more memories that are part of end-user devices to which users 14 have access.

It should be understood that the instructions stored in a memory may comprise a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include a processor, storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium.

FIG. 3 depicts exemplary components of the present invention and their relationship to social events 18, users 14 and social apps 20 in accordance with one embodiment of the invention. As shown, the system 19 may comprise the following functional modules or subsystems, each of which are completed at least by one or more processors executing instructions stored on one or more memories or computer readable mediums:
Event info importer 191—automatically imports salient event parameters
Event template editor 192—enables crowd sourced creation, editing, and correction (where correction implies crowd source based correction by users 14 of incorrect facts provided by an individual user) of unique analytics and visualization templates for events
User preference editor 199—enables user to enter items used to determine communications, visualizations, or recommendations of interest
Geo spatial interface 193—allows automatic input of geo spatial information from devices
Social media interface 194—allows automatic consumption and generation of social media communications, including the automatic generation of high priority communications on user defined high priority communication channels based on analytics
App db 195—persists AAVOSE 19 application related information
Social media bigdata 196—persists social media communications and analytic results
Event Analytics 197—performs the various analytics
Event Visualizer 198—presents the analytics results and allows for easy generation of social media communications.

The modules 191-198 shown in FIG. 3 and further described herein are just exemplary. It should be understood that the present invention is not limited to the modules described herein and may contain other conventional modules which may be required to perform general “housekeeping” functions such as marketing, advertising, billing, technical support and error handling.

In an embodiment of the invention the event info importer 191 may be operable to help to automate the importing of an event's salient characteristics. The characteristics include but are not limited to the event schedule 11, the event map 13, and the event media 12. Event schedules 11 information which can be imported include but are not limited to the time and tracks of the event. Event maps 13 information which can be imported include but are not limited to the physical locations with geo spatial parameters, and the virtual locations of the event. Event Media 12 on typical event websites 10 are currently limited to static keywords such as event hashtags or the event sponsor's 17 user handles on twitter or other social networks. Event Media 12 information that can be imported by the Event info importer 191is usually much broader and includes but is not limited to the following: event hashtag, event user handles, speaker/presenter/performer user handles, event session titles, event abstracts, pictures, sounds/music, and videos. The event info importer 191 may be implemented as instructions on a server connected to Internet, with part of those instructions configured to run in the users' 14 client devices' browser and local programs, applications or applets.

The event template editor 192 may be operable to allow registered users of the system 19 (users 14) to create and edit the unique analytics and visualization templates for events 18. Allowing users 14 to create application content is also known in the art as crowd sourcing. Users 14 can use the event info importer 191 to import event information from the event website 10 and other sources such as news feeds. Users 14 can create/edit/correct unique analytics and visualization templates for events with the ability to define the temporal aspects of the events such as time schedules and tracks, the spatial aspects of events such as different rooms, generalized maps, or maps with exact geospatial locations, the relational aspects of events such as speaking users, follower users, following users, and influencing users and the media aspects of events such as keywords, pictures, sounds, and videos. Again the aforementioned characteristics are just examples. Other generalized, event type specific, and event specific characteristics are envisioned by the inventors. The event template editor 192 may be implemented as instructions on a server connected to Internet, with part of those instructions configured to run in the users' 14 client devices' browser and local programs, applications or applets.

The user preference editor 199 may be operable to allow users 14, event sponsors 17, or business partners 21 to define preferences which (in addition to the event analytics 197) help determines the “signal” communications of interest among all the “noise” of uninteresting communications. The interesting communications can be defined any communications, metadata related to those communications or any additional user entered information. By way of example, such as user entered information could include user preferences or user configured groups. The user preference editor 199 may be operable to allow users 14 to easily and/or automatically tag their various relationships to other users 14 such as speakers, followers, following, and influencing with various user customized groups, priorities, or interests. The user preference editor could also automatically import user preferences from other applications in general. Examples of information which could be imported include “to do” lists, schedules, or any other social apps 20 data or metadata. Additional potential interests or focus aspects of the “signal” or communications of interest include topics and subjects users 14 are interested in, people that the users 14 follows (or any other relations), locations that users 14 are interested (such as the main presentation room), the time/dates the users 14 will be attending the event 18, etc. The user preference editor 199 may be implemented as instructions stored in memory configured to run on a processor of a set of server connected to Internet, with part of those instructions configured to run in the users' 14 client devices' browser and local programs, applications or applets.

The event geospatial interface 193 may be operable to receive geospatial data from end user devices used by the user. The event geospatial interface 193 may be implemented as instructions on a server connected to Internet, with part of those instructions configured to run in the users' 14 client devices' browser and local programs, applications or applets.

The event social media interface 194 may be operable to act as a bridge between the system 19 and various social media apps 20. The social media interface 194 enables receiving communications and other metadata associated with the communications from the social apps 20. The social media interface 194 formats and transmits communications generated in the event visualizer 198 to the social apps 20. The social media interface 194 can be configured to receive from and transmit to multiple social media apps 20 simultaneously. The event social media interface may be implemented as instructions stored in a memory configured to run on a processor of a server connected to the Internet.

The app db 195 may be operable to persist system 19 application related information. Examples of application information include but are not limited to configuration information, user information, end-device information, and user preferences. The app db 195 may be implemented as a standard SQL database as instructions stored in a memory configured to run on a processor of a set of server connected to the Internet.

The social media big data 196 may be operable to persistsocial media communications, the communication metadata, and analytic results in a scalable platform. The social media bigdata 196 may be implemented as a scale out NOSQL software platform which consists of instructions stored in a memory configured to run on a processor of a set of servers connected to the Internet, for example.

The event analytics 197 may be operable to perform various real-time and batch analytics on data in the social media bigdata 196 platform. Summarized analytics results may also be stored in the same social media bigdata 196 platform. Analytics may be historical summaries as well as predictive and proscriptive. Examples of analytics include but are not limited to:
Historical, real-time or predictive ranking of the hottest (most popular) social events occurring now or over a particular time frame (future or past)
Historical, real-time, or predictive ranking of the most popular sessions within an event based on the any number of factors such as the number of followers of a particular speaker, the number of communications or tweets about a given session, the number of key influencers at a particular session, the number of amplifications or retweets in a particular session, and/or natural language processing of the communications.
Historical, real-time, or predictive analytics of interest customized to individual users 14 based on user actions, user preferences, user followers, user following, user retweets, natural language processing of the communications, and/or any other user metadata that might be derived or accessible from the social apps 20.
Historical, real-time, or predictive analytics of interest customized for business partners 21 based user actions, user preferences, user followers, user following, user retweets, natural language processing of the communications, and/or any other user metadata that might be derived or accessible from the social apps 20.
Trending and summary data intended for event sponsors 17. E.g. analytics to show how particular topics or speakers have gained or lost popularity over a time period.
Real-time feedback and analysis for presenters/speakers so that they can tailor content/presentation on-the-fly. Real-time feedback for demo-ers at a trade show so they can adjust their demonstrations.
Automated conference summaries/reviews based on the communications (tweets) information—not only which topics were popular, which keynote was popular etc, but also a summary (using NLP and text summarization) of what the main influencers said in their tweets. These summaries can be done at the end of the event 18, or several times/day, or near real-time so that the event sponsors 17 have a real pulse on the event.
Users 14 can receive a summary of how well-rated/liked a speaker/presenter is in prior conferences, let's say over a given time period.
Users 14 can examine other conferences influencers attend. E.g. at Strataconf this year, a user named @imrantech had great comments, was 5-th most re-tweeted. Hence users 14 would like know which other conferences @imrantech attends and likes.
Analytics for business partners 21 such as corporations that host or participate in hundreds of events 18 (meetings/conferences/offsites/tradeshows) many of which are internal (e.g. IBM or Microsoft) to get an understanding of participation/engagement/relevance etc.
Users 14 can filter out other users based on relationships, or customized tags. E.g. tags for friends, families, coworkers, official group members and so on.
Analytics could be used to provide users 14, event sponsors 17, or business partners 2l with recommendations and/or reminders. By way of example only recommendations could include new communications to originate or amplify, or new users 14, events 18, or business partners 21 to build relationships with.
Ability to provide background information to the user to prepare for a meeting. This can be based on analysis of the speakers previous work or other work related to the topic.
Ability to natural language processing in conjunction with other imported data to determine “signals” or communications or users of interest.

The event analytics 197 may be implemented by a processor or processors executing instructions stored in memory configured as a set of servers connected to Internet. Yet further, in an embodiment of the invention part of those instructions may be executed by a processor that is part of users' 14 client devices' (e.g., part of a browser, local programs, applications or applets).

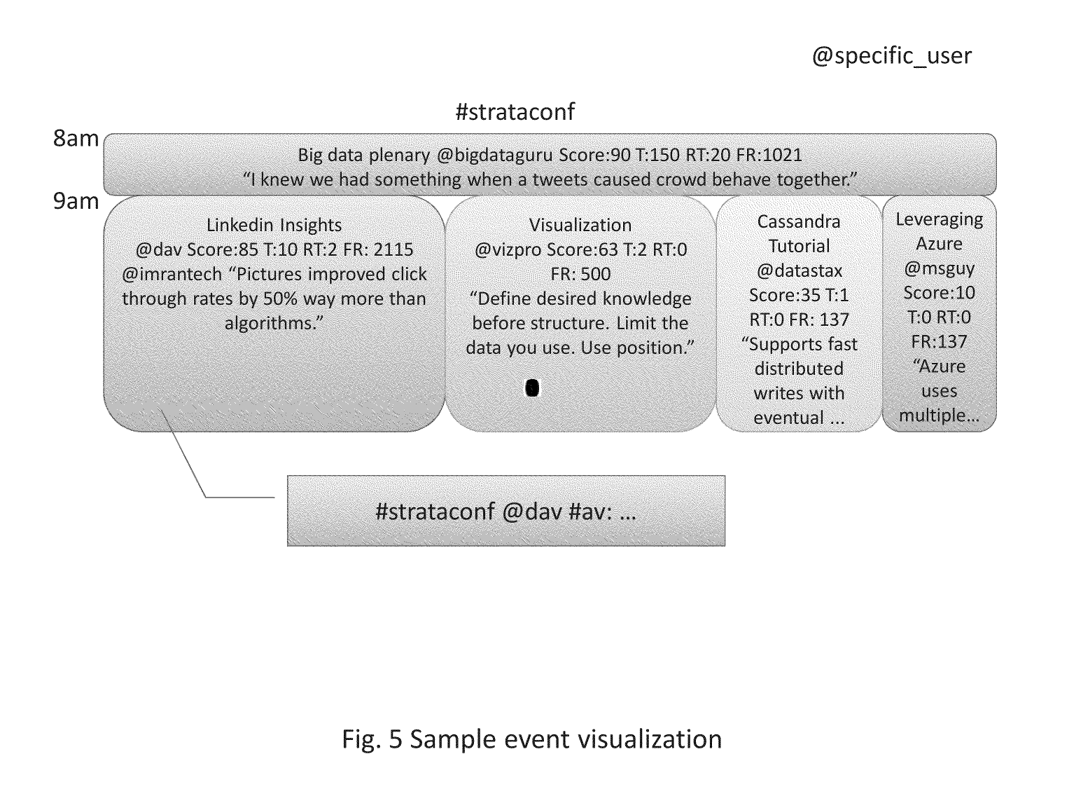

Event Visualizer module 198 may be operable to present the analytical results, allow for easy generation of social media communications, and provide insights for business partners. An example of visualized results for a conference with multiple tracks is shown in FIG. 5. In this example, each session is color coded, sized, and/or ordered based on its relevancy to the specific user. By way of example, the relevancy score can be calculated based on a combination of a number of items including but not limited to: the speaker's followers, the speakers following users, the speakers past amplification scores, the number of the viewing user's followers or following users related to the speakers followers, the number of recent communications of the speaker or his followers, and/or any other metadata that can be imported, derived, or calculated from data and metadata available in the social apps 20. If the users 14 wish to initiate a communication or tweet for a particular session, they simply click on the session of interest and a preformed tweet with relevant key words is presented for editing and submission, thereby saving the user time and effort in sending a relevant communication or tweet.

Other visualization examples include:
A graph showing the influence/amplification/retweets for the conference or a particular session.
A three dimensional graph of communication activity in the conference.
Aggregations showing business partner analytics on ad campaigns such as popularity, click thru rates, time series comparisons and so on.
Trending graphs/bar graphs intended for event sponsors 17. E.g. popularity of a specific topic over a time period.
An event 18 linkage graph-showing what other conferences do the most influential/followed individuals also attend and what does that linkages look like.
A visualization could provide a prioritized set of recommendations and/or reminders. By way of example only recommendations could include new communications to originate or amplify, or new users 14, events 18, or business partners 21 to build relationships with.
A visualization to encourages users to provide feedback. Mechanism to provide feedback. Incentives to users 14 include access to supplementary information provided by speakers, or event sponsors 17 business partners 21 or other users 14.
Allows users “visualize” the conference from their focus aspects or based on their manually/automatically determined “signals” of interest. By way of example only such visualizations could include highlighting a presentation that is a topic the user is interested in, attended by people that the user follows, and/or is at held at a location that the user likes;
A visualization which suggest a calendar to the user which best matches the user's interests or focus aspects.
A visualization which suggest potential gathering time/locations to both users 14 and those people the users 14 follow.
Report to users 14 on a real time base events that are most related to the users' interests or focus aspects;
A visualization to summarize past events 18 and predict future events 18 that are most related to users' 14 interest or focus aspects.

In embodiments of the invention the visualizations generated by the system 19 may be configurable. They may provide defaults, and allow users 14 to change format, color, style of visualization. They may also allow users 14 to drill-down to get underlying details if applicable.

The event visualizer module 198 may be also implemented by a processor or processors executing instructions stored in memory configured as a set of servers connected to Internet. Yet further, in an embodiment of the invention part of those instructions may be executed by a processor that is part of users' 14 client devices' (e.g., part of a browser, local programs, applications or applets).

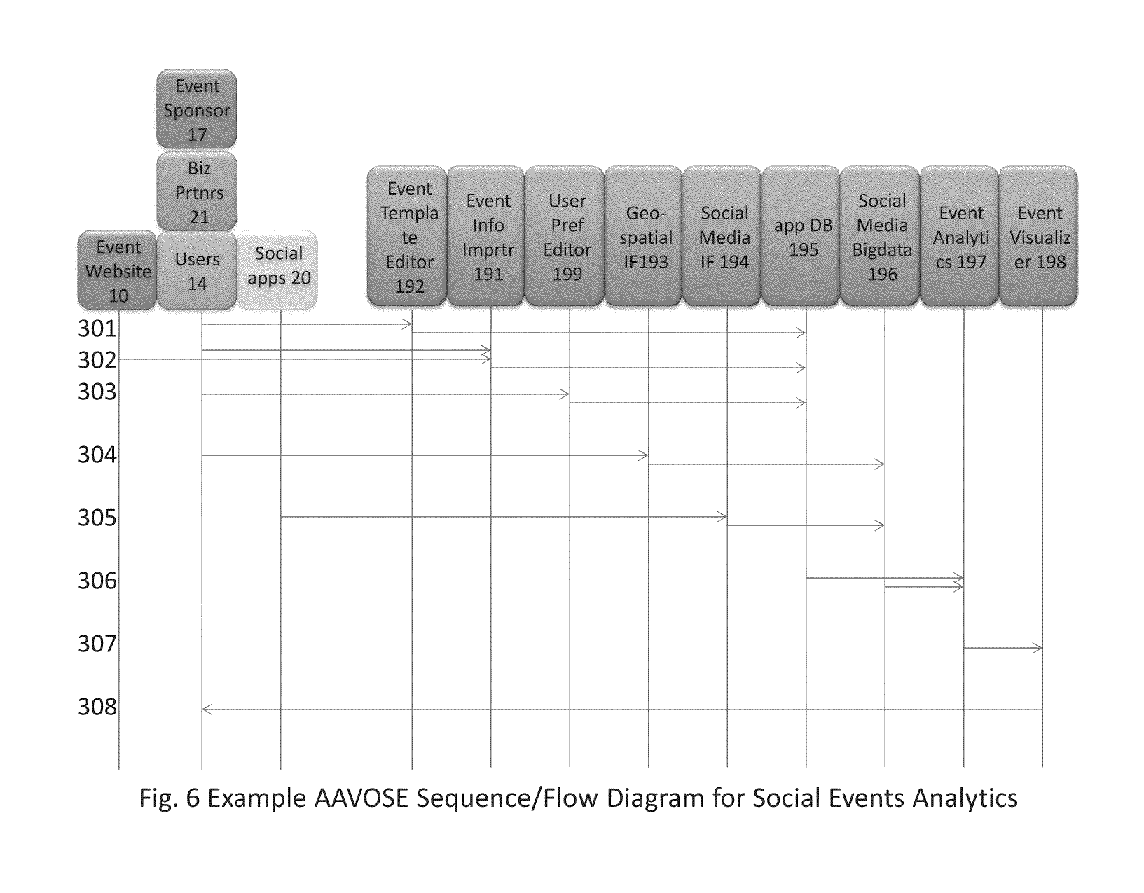

FIG. 6 depicts an exemplary sequence or flow diagram for social event analytics that may be implemented by system 19. The steps described are by way of example and may be followed to produce the visualization shown in FIG. 5, for example. For the purposes of FIG. 6 “users” 14 includes event sponsors 17 and business partners 18. It should be understood the order of the steps shown in FIG. 6 may be changed for different analytics and visualization functions. The example steps are as follows:
In step 301, users 14 may log in to the system 19 via oauth (or another authorization) or other social apps 20 supported by API. The users 14 may use the event template editor 192 module to create or edit an event. This data may be stored in the app DB 195 module.
In step 302, users 14 may use the event info importer 191 to import event features from the event website 10. This data may also be stored in the app DB 195 module.
In step 303, users 14 may edit and set their manual user preferences 199.
In step 304, users 14 may configure a mobile device executing a social app to send geospatial data to servers that are part of system 19 via the Internet. This data may be stored in the social media bigdata 196 storage module.
In step 305, social apps 20 may generate communications and meta data which then may be stored in the social media bigdata 196 storage module.
In step 306, event analytics 197 module may be operable to retrieve data from the app db 195 module and the social media big data 196 module and perform user specific popularity analysis for event communications.
In step 307, event visualizer 198 module may be operable to provide visualizations of the analytics results. A sample visualization is shown in FIG. 5.
In step 308, users 14 may be operable to retrieve and interact with the visualization from the event visualizer 198 module.

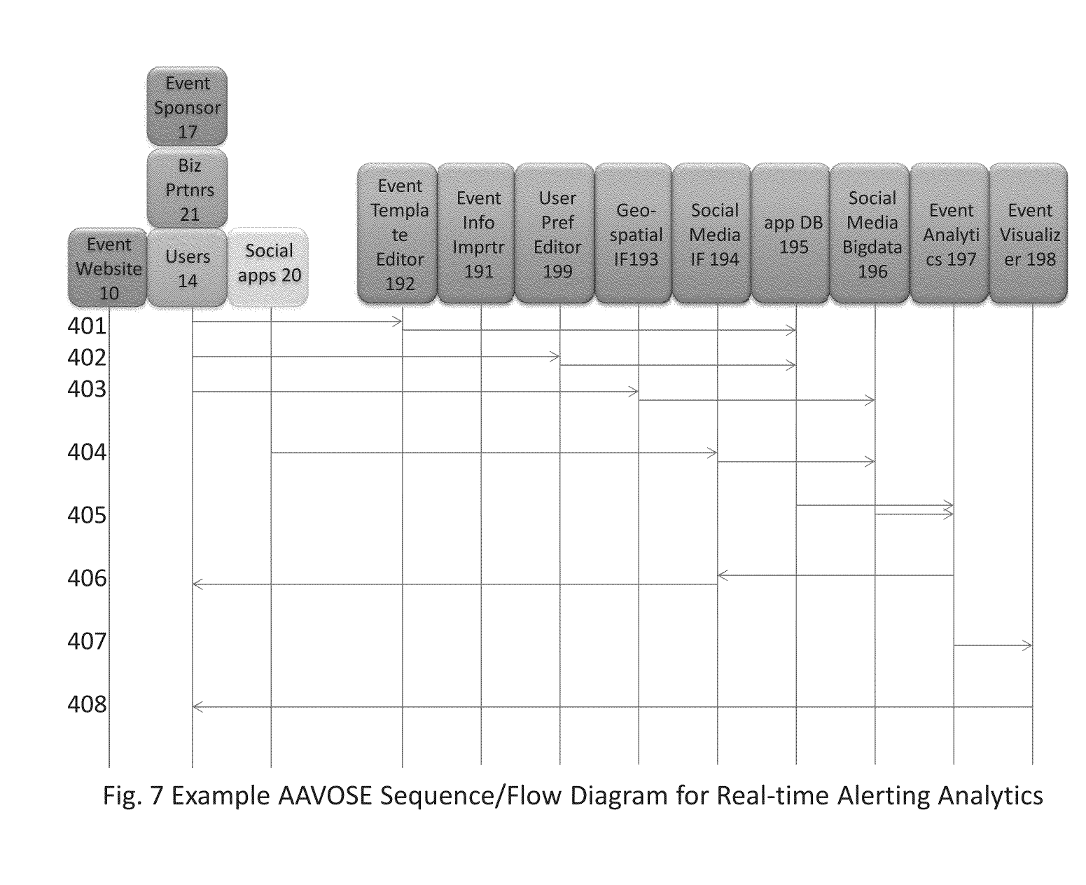

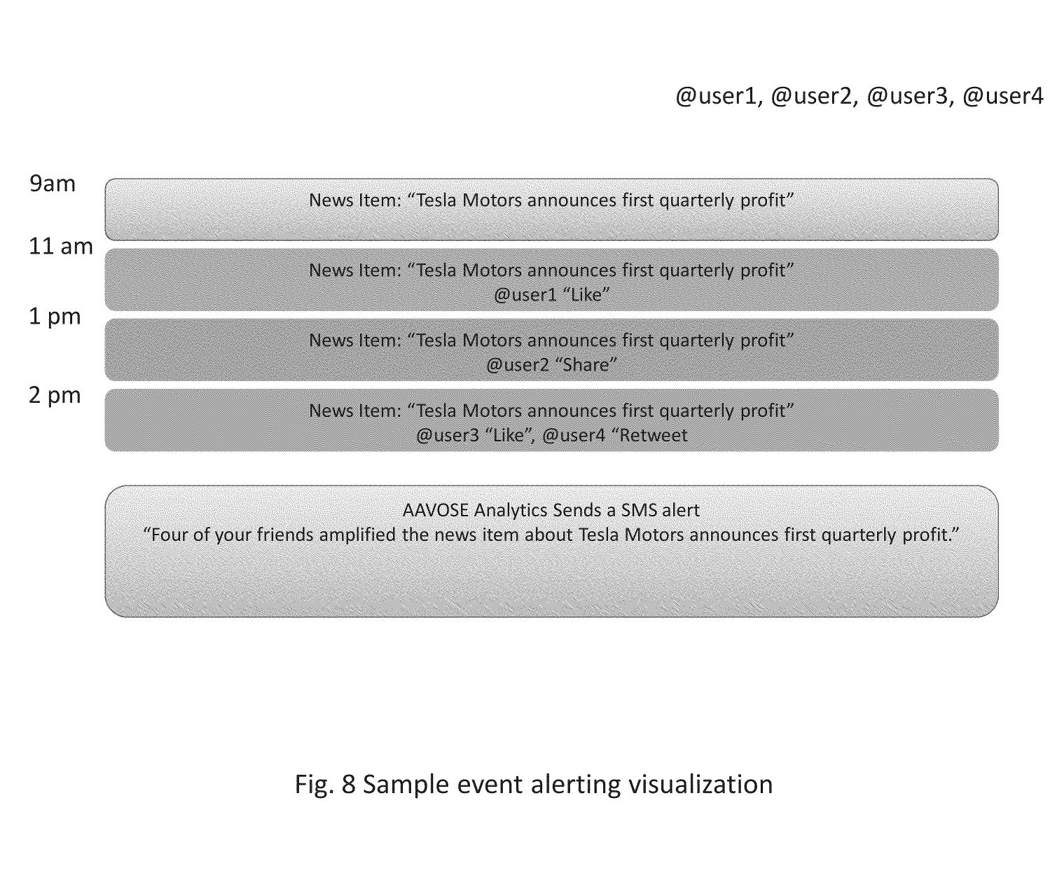

FIG. 7 depicts another exemplary sequence or flow diagram. This diagram relates to real-time alerting analytics. The steps described are by way of example, and may be used to produce the visualization shown in FIG. 8. For the purposes of this diagram users 14 include event sponsors 17 and business partners 18. It should be understood the order of these steps may be changed for different analytics and visualization functions. The exemplary steps are as follows:
In step 401, users 14 may log in to the system 19 via oauth (or another authorization) or other social apps 20 supported API. The users 14 may use the event template editor 192 module to create or edit an event where the event parameters may include the follow user or user groups of interest, social app selection, example communication of interest, keywords in the communication, time preferences, geospatial parameters, and alerting channel preferences. This data may be stored in the app DB 195 module.
In step 402, users 14 may edit and set their manual user preferences 199. Example preferences include which social networks, the social net credentials, the alerting channels, the alerting channels credentials, and the global alerting time frames.
In step 403, users 14 may configure a mobile social app on a user device 14 to send geo spatial data to one or more servers making up system 19 via the Internet. This data may be stored in the social media bigdata 196 storage module.
In step 404, social apps 20 may generate communications and meta data which then may be stored in the social media bigdata 196 storage module.
In step 405, event analytics 197 module may retrieve data from the app db 195 module and the social media big data 196 module and perform user specific popularity analysis for event communications.
In step 406, analytics may trigger an alert and the communications of interest may be forwarded to an alerting communications channel by the Social Media Interface 194 module which may then be received by the user 14 in real-time.
In step 407, event visualizer module 198 may provide visualizations of the analytics results. A sample visualization is shown in FIG. 8
In step 408, users 14 may retrieve and interact with the visualization from the event visualizer 198.

The present invention is not limited to the applications disclosed herein, but may be utilized for any type of media or other application to enable analysis and visualization of social events.

From the foregoing description, it will be appreciated that the invention makes available a novel system and method for the analysis and visualization of social events.

Having described some embodiments of the invention, it is believed that other modifications, variations and changes will be suggested to those skilled in the art in view of the teachings set forth herein. It is therefore to be understood that all such variations, modifications and changes are believed to fall within the scope of the present invention.

We claim:

1. A system for analyzing and visualizing social events comprising:
a hardware server operable to execute instructions stored on one or more memories for,
obtaining general preferences, and event specific information from users,
receiving a communication from at least one social network,
analyzing the received communication in combination with the general preferences and event specific information.

2. The system in claim 1 wherein the hardware server is further operable to execute stored instructions for sending an alert to a user via a user defined high priority communications channel.

3. The system in claim 1 wherein the hardware server is further operable to execute stored instructions for creating a custom visualization about an event.

4. The system in claim 1 wherein the event specific information is comprised of at least one of a group consisting of at least: key words in the communication, date/time ranges of the communication, geospatial metadata of the communications, retweets/likes of the communication, the number of friends/followers/following users interacting with the communication.

5. The system in claim 1 wherein the hardware server is further operable to execute stored instructions for natural language processing or semantic analysis of the communication.

6. The system as in claim 5, wherein the hardware server is further operable to execute stored instructions for completing analytics by extracting common features from the communication and comparing new communications for similar or different features.
